(19) United States
(12) Patent Application Publication
(10) Pub. No.: US 2013/0295273 A1
(43) Pub. Date: Nov. 7, 2013

(54) SOLUTION AND METHOD OF TREATING A SUBSTRATE WITH THE SOLUTION

(71) Applicant: BASF SE, Ludwigshafen (DE)

(72) Inventors: Glenis R. Mente, Grosse Ile, MI (US); Donald C. Mente, Grosse Ile, MI (US); John P. Erickson, Southgate, MI (US)

(21) Appl. No.: 13/872,225

(22) Filed: Apr. 29, 2013

Related U.S. Application Data
(60) Provisional application No. 61/640,949, filed on May 1, 2012.

(51) Int. Cl. A01N 3/00; A01G 13/00

(52) U.S. Cl. CPC A01N 3/00; A01G 13/00
USPC 427/2.11; 106/287.25; 47/57.7

(57) ABSTRACT

A solution and a method of treating a substrate with the solution is disclosed. The solution includes a polar liquid component and at least 2% by weight based upon the total weight of said solution of an adduct that is different from the polar liquid component. The adduct comprises at least one of:
(D) NH₂Y(HNCO(AO)_{X}OR)_{Z1};
(E) (RO(AO)_{X} CONH)_{Z2}YHNCONHY(HNCO (AO)_{X}OR)_{Z3}; and
(F) Y(HNCO(AO)_{X}OR)_{Z4}
where
Y is an aromatic core derived from an aromatic isocyanate component;
A is an alkylene group selected from the group of ethylene groups, propylene groups, butylene groups, and combinations thereof;
R is a hydrocarbon group having from 1 to 20 carbon atoms;
X is at least 6;
Z₁ is at least 1;
Z₂ is at least 1;
Z₃ is at least 1; and
Z₄ is at least 2.

Further, the adduct is substantially free of unreacted isocyanate groups.

### BACKGROUND OF THE INVENTION

1. Field of the Invention

The instant invention generally relates to a solution and a method of treating a substrate with the solution. More specifically, the instant invention relates to a solution comprising an adduct of an isocyanate component and a polyether monol.

2. Description of the Related Art

Control of water evaporation is an important consideration for many applications, especially in the agricultural, landscaping, and construction industries. As one example, top spray irrigation methods in the agricultural and landscaping industries generally have poor efficiency, which is partially attributable to loss of water through evaporation. Thus, it is desirable to minimize evaporation to increase the availability of irrigation water and “naturally sourced” water, such as rain and dew, for uptake by botanical articles such as agricultural crops, grass, and decorative plants. In the construction industry, airborne dust is often annoying and can cause health problems or damage to machinery. Water is often used to for dust control at construction sites or on dirt roads. However, atmospheric dust may become a problem upon drying of wetted surfaces such that it is desirable to minimize evaporation of the water to lengthen the time period over which dust control treatment is effective.

Methods of slowing water evaporation, especially for landscaping applications, have been explored in the past. For example, lawn seed compositions including a combination of absorbent fibrous materials and grass seed have been employed, with the absorbent fibrous materials serving to slow evaporation of water to promote growth of the grass seed. However, application of such combinations can be cumbersome, with wet application of such compositions being hindered by difficult pumpability due to the presence of the absorbent fibrous materials.

Absorbent polymers have previously been developed. For example, super absorbent polymers (often referred to in the art as SAPs) are well-known for various applications and have the ability to absorb many times their weight in water. SAPs are available commercially in a variety of chemical forms, including substituted and unsubstituted natural and synthetic polymers, such as hydrolysis products of starch acrylonitrile graft polymers, carboxymethylcellulose, cross-linked polyacrylates, sulfonated polystyrenes, hydrolyzed polyacrylamides, polyvinyl alcohols, polyvinylpyrrolidones, polyacrylonitriles and the like. SAPs are known for use in various applications such as in sanitary articles or other applications where the function of liquid absorption is of primary focus. However, many SAPs do not readily release liquid once the liquid is absorbed such that many SAPs may not be ideal for hydration applications in which there is a desire to slow evaporation of liquid while still providing for release of the liquid into the surrounding environment.

Adducts of isocyanates and polyester monols have been utilized in the art as lubricants, surfactants, and thickeners within resin systems that include other urethane-containing compounds. Additionally, polyester monols have been utilized in isocyanate prepolymers, in which the monols are utilized to partially cap polyisocyanates with isocyanate groups remaining in the isocyanate prepolymer for further reaction.

In view of the foregoing, there remains an opportunity to provide a novel composition and method for slowing evaporation of a liquid into the surrounding environment without binding the liquid to an extent that the composition cannot be used for hydration applications.

### SUMMARY OF THE INVENTION AND ADVANTAGES

The subject invention is directed to a solution and a method of treating a substrate with the solution. The solution includes a polar liquid component and at least 2% by weight based upon the total weight of the solution of an adduct that is different from the polar liquid component. The adduct comprises at least one of:
(A) NH₂Y(HNCO(AO)_{X}OR)_{Z1};
(B) (RO(AO)_{X} CONH)_{Z2}YHNCONHY(HNCO (AO)_{X}OR)_{Z3}; and
(C) Y(HNCO(AO)_{X}OR)_{Z4}
where
Y is an aromatic core derived from an aromatic isocyanate component;
A is an alkylene group selected from the group of ethylene groups, propylene groups, butylene groups, and combinations thereof;
R is a hydrocarbon group having from 1 to 20 carbon atoms;
X is at least 6;
Z₁ is at least 1;
Z₂ is at least 1;
Z₃ is at least 1; and
Z₄ is at least 2.

The adduct is substantially free of unreacted isocyanate groups. The method includes the steps of providing the solution and applying the solution onto the substrate.

Due to the presence of the adduct in the solution, the solution exhibits slow evaporation of the polar liquid component into the surrounding environment without the adduct binding the liquid to an extent that the composition cannot be used for hydration applications.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a graph showing the impact of Example 1 and Comparative Examples 1-3 on the water retention of soil over a range of pressures;

FIG. 2 is a graph showing the impact of Example 2 and Comparative Examples 4-6 on the water retention of soil over a range of pressures; and

FIG. 3 is a graph showing the impact of Example 3 and Comparative Examples 7-9 on the water retention of soil over a range of pressures.

### DETAILED DESCRIPTION OF THE INVENTION

A solution and a method of treating a substrate are provided herein. The solution comprises a polar liquid component and an adduct that is different from the polar liquid component. The adduct has an ability to retain the polar liquid component. In particular, the adduct slows the rate of evaporation or loss of the polar liquid component from the solution after treating the substrate with the solution. Even after evaporation or loss of the polar liquid component from the solution, the adduct may remain on the substrate. As such, the adduct remaining on the substrate can retain polar liquids that are subsequently applied onto the treated substrate, thereby slowing evaporation or loss of the subsequently applied polar liquids. The solution is ideal for applications in which it would be desirable to slow evaporation or loss of polar liquids from substrates, such as in the agricultural, botanical, and construction industries as described in further detail below.

As set forth above, the solution comprises the polar liquid component. In this regard, the polar liquid component is miscible with water. The “polar liquid component” refers to any polar compound or combination of such compounds that is liquid at ambient temperature of about 21° C. and that is present in the solution (save for distinct components referred to herein, such as the adduct, that are specifically defined as different from the polar liquid component). Thus, the polar liquid component may contain one or more polar liquid compounds including, but not limited to, water; alcohols such as methanol, ethanol, propanol, and butanol; acids such as acetic acid and formic acid; and combinations thereof. For most applications, the polar liquid component typically includes substantially only water, especially for hydration applications involving treatment of botanical articles such as grass, crops, or seeds. Stated differently, in this embodiment the polar liquid component typically only includes water, but impurities or other compounds that may fit the definition of a polar liquid compound but that are unintended for inclusion in the solution may also be present within the solution in trace amounts (i.e., in combined amounts of less than or equal to 1% by weight based upon the total weight of the polar liquid component). In addition to or as an alternative to water, the polar liquid component may include an antifreeze compound such as propylene glycol and/or ethylene glycol. It is to be appreciated that the instant invention is useful for any application in which retention of any polar liquid component is desired (with slowing of evaporation or loss of the polar liquid component desired) such that certain applications may benefit from a combination of polar liquid compounds present in the solution as the polar liquid component, or may benefit from the presence of polar liquids other than water.

The amount of the polar liquid component present in the solution is typically only limited by the amount of other components present in the solution. In other words, the polar liquid component is typically present as a balance of the solution after threshold amounts of the adduct are met, and after optional desired components are included. Typically, the polar liquid component is present in the solution in an amount of from 25 to 95% by weight, alternatively from 40 to 95% by weight, alternatively from 70 to 95% by weight, all based upon the total weight of the solution.

As alluded to above, the adduct is different from the polar liquid component. Thus, while the term “polar liquid component” is broad and may generally encompass the adduct as defined herein under certain circumstances, the adduct is separate from and present in addition to any compounds that are encompassed by the definition of the “polar liquid component”. The adduct comprises at least one of:
(A) NH₂Y(HNCO(AO)_{X}OR)_{Z1};
(B) (RO(AO)_{X} CONH)_{Z2}YHNCONHY(HNCO (AO)_{X}OR)_{Z3}; and
(C) Y(HNCO(AO)_{X}OR)_{Z4}

where Y is an aromatic core derived from an aromatic isocyanate component; A is an alkylene group selected from the group of ethylene groups, propylene groups, butylene groups, and combinations thereof; R is a hydrocarbon group having from 1 to 20 carbon atoms, alternatively from 1 to 10 carbon atoms, alternatively from 1 to 5 carbon atoms; x is at least 6, alternatively from 10 to 90, alternatively from 15 to 70; Z1 is at least 1, alternatively at least 2, alternatively from 1 to 4; Z2 is at least 1, alternatively at least 2, alternatively from 1 to 4; Z3 is at least 1, alternatively at least 2, alternatively from 1 to 4; and Z4 is at least 2, alternatively from 2 to 4.

As alluded to above, “Y” is derived from the aromatic isocyanate component and can include one or more aromatic rings therein. For example, “Y” can represent, but is not limited to, a toluene group, a methylene diphenylene group, or polymethylene polyphenylene group. It is believed that “Y” enables the adduct to remain on the substrate even after evaporation or loss of the polar liquid component from the solution. Without being bound by theory, it is believed that the non-polar portions of the adduct are attracted to the non-polar portions of the substrate and the polar portions of the adduct, in this case the aromatic groups of the adduct derived from “Y”, are attracted to the polar portions of the substrate as well as the polar liquid, which enables the adduct to remain on the substrate even after evaporation or loss of the polar liquid component from the solution. By “derived”, it is meant that the structure “Y” is introduced into the adduct as part of the aromatic isocyanate component that is reacted to form the adduct. “Y” enables the adduct to adhere to substrates to which the solution is applied and assists the adduct with resisting removal when exposed to environmental conditions (such as through repeated washing cycles) once the adduct is disposed on the substrate. When the solution is applied to substrates such as crops or other landmass, the adducts thus resist removal from the substrate when exposed to rain such that the beneficial water-retention effects of the adducts can be realized over extended periods of time without the need for reapplication of the solution.

Urethane linkages present in the adduct and shown in (A), (B), and (C) above are created as a result of reaction of isocyanate groups that are present in the aromatic isocyanate component, prior to reaction, and hydroxyl functionality (as described in further detail below). To these ends, isocyanate functionality is not present in the structure represented by variable “Y” (save for possible residual unreacted isocyanate that is addressed below). Likewise, variable “Y” typically does not include any urethane linkages within the structure thereof. Rather, the structure of “Y” includes structure of the aromatic isocyanate component that remains after reaction of the isocyanate functionality present therein, with the resulting urethane-bonded groups represented by the structure contained in the parenthetical whose number is indicated by “Z1”, “Z2”, “Z3”, and “Z4”. Additionally, alternative urethane-bonded groups other than those represented in the parenthetical whose number is indicated by “Z1”, “Z2”, “Z3”, and “Z4” are typically not present in the adduct. While specific aromatic isocyanate components are described in further detail below, common isocyanates such as diphenylmethane diisocyanate would result in a structure for “Y” of diphenylmethane.

The adduct is preferably non-reactive and, as such, is typically substantially free of unreacted isocyanate groups. More specifically, substantially all isocyanate groups that are present in the aromatic isocyanate component prior to reaction are reacted during formation of the adduct. By “substantially free” and “substantially all”, it is meant that the adduct is formed with the intent of and conditions for reacting all isocyanate groups. To the extent that any unreacted isocyanate groups remain in the adduct, the presence of such unreacted isocyanate groups is the result of incomplete reaction that may occur under actual laboratory or production conditions.

In one embodiment, the adduct comprises greater than 95% by weight (C) based on the total weight of the adduct. In this particular embodiment, the value of variable “Z4” in (C) above is typically substantially identical to the number of isocyanate groups that are present in the aromatic isocyanate component prior to reaction, with possibly trace unreacted isocyanate groups accounting for any other groups that are bound to Y.

The portion of (A), (B), and (C) above represented by (AO)_{X}, “AO” can represent the same or different groups. More specifically, while “x” represents the number of groups indicated by “AO”, the actual identity of “AO” need not be identical throughout the portion of (A), (B), and (C) represented by (AO)_{X}. For example, within (AO)_{X}, “AO” may represent any combination of ethyleneoxy groups, propyleneoxy groups, and butyleneoxy groups may be present (depending, of course, on the value of “x”). Typically, a majority of “AO” groups present in (AO)_{X} are ethyleneoxy groups, which tend to be more hydrophilic than other alkyleneoxy groups and which promote binding between the adduct and the polar liquid component and polar substrate components. Typically, ethyleneoxy groups are present in an amount of from 85 to 100% by mole, alternatively from 85 to 99.9% by mole, based upon the total number of alkyleneoxy units present in (AO)_{X}. However it is to be appreciated that from 0.1 to 15% of “AO” groups can be other alkyleneoxy groups. For example, propyleneoxy groups may be present in an amount of from 0.1 to 15% by mole, alternatively 10 to 15% by mole, based upon the total number of alkyleneoxy units present in (AO)_{X}. As another example, butyleneoxy groups may be present in an amount of from 0.1 to 10% by mole, alternatively 8 to 10% by mole, based upon the total number of alkyleneoxy units present in the portion of the (AO)_{X}. In one embodiment, substantially all “AO” groups are ethyleneoxy groups.

As set forth above, variable “R” in (A), (B), and (C) above is a hydrocarbon group having the above-specified number of carbon atoms. Typically, R is further defined as a linear hydrocarbon chain. As set forth in further detail below in the context of the manner in which the adduct is made, the hydrocarbon group represented by “R” may be derived from an initiator molecule that is alkoxylated to form the portion of the adduct represented by (AO)_{X}OR in (A), (B), and (C) above. In another embodiment, “R” may be derived from a capping agent that is employed to terminate an alkoxylation reaction that results in the portion of the adduct represent by (AO)_{X}. In both scenarios, “R” is typically derived from a monol, i.e., a mono-functional alcohol, having the above-specified number of carbon atoms. Furthermore, “R” always terminates the chain represented by (AO)_{X}OR.

As described above, the adduct comprises at least one of (A), (B), and (C). Typically the adduct comprises a mixture of (A), (B), and (C). Of course, variations in reactants and processes utilized to form the adduct yield embodiments of the adduct having different ratios of (A), (B), and (C).

Although (A), (B), and (C) have different structures, they have similar features as a result of being formed from common reactants, e.g. isocyanates, polyether monols, etc. (A) has a number average molecular weight of at least 500 g/mol, alternatively from 1,000 to 5,000 g/mol, alternatively from 2,000 to 4,000 g/mol. (B) has a number average molecular weight of at least 1,000 g/mol, alternatively from 1,000 to 20,000 g/mol, alternatively from 6,300 to 15,000 g/mol. (C) has a number average molecular weight of at least 1,000 g/mol, alternatively from 1,000 to 15,000 g/mol, alternatively from 6,300 to 10,000 g/mol. These molecular weights enable the adduct to retain the polar liquid component, primarily through controlling or slowing the rate of evaporation of the polar liquid component. However, unlike other water-retaining polymers such as poly(methyl) methacrylate, the adduct does release the polar liquid component at a rate that is effective for hydration or other treatment applications in which it is desired to provide the polar liquid component to the substrate. The number average molecular weight of (A), (B), and (C) is controlled primarily through the type of aromatic isocyanate component that is employed (based upon the number of free isocyanate groups present in the aromatic isocyanate component) and the value of “x”, although it is to be appreciated that other variables can also control the number average molecular weight such as the content of “R”, and the relative amounts of ethyleneoxy, propyleneoxy, and butyleneoxy groups present in the adduct, and water in the initial monols.

In one embodiment, the adduct typically includes greater than or equal to 10% and more typically includes greater than or equal to 20% by weight (A) based on the total weight of said adduct. In this embodiment (A) has a number average molecular weight of from 500 to 5000 g/mol and includes ethyleneoxy groups in an amount of from 85 to 99.9% by mole based upon the total number of alkyleneoxy units present in (AO)_{X} of (A).

In another embodiment, the adduct typically includes greater than or equal to 90% and more typically greater than or equal to 95% by weight (C) based on the total weight of the adduct. In this embodiment (C) has a number average molecular weight of from 6,300 to 10,000 g/mol and includes ethyleneoxy groups in an amount of from 85 to 99.9% by mole based upon the total number of alkyleneoxy units present in (AO)_{X} of (C).

In one specific embodiment of the adduct, “R” is a methyl group, (AO)_{X} contains all ethyleneoxy groups, “z” is about 2, and “Y” is derived from toluene diisocyanate, with the adduct having a number average molecular weight of from 6000 to 7000 g/mol, typically about 6150 g/mol. In another specific embodiment of the adduct, “R” is a methyl group, (AO)_{X} contains all ethyleneoxy groups, “z” is about 2, and “Y” is derived from diphenylmethane diisocyanate, with the adduct having a number average molecular weight of from 6000 to 7000 g/mol, typically about 6300 g/mol.

While it is to be appreciated that the adduct described herein is not limited to any particular manner of production, in one embodiment, the adduct comprises the reaction product of the aromatic isocyanate component and a polyether monol. In this embodiment, the polyether monol is formed prior to reaction with the aromatic isocyanate component, which enables precise control of the number average molecular weight of the polyether monol and of the final.

The polyether monol comprises the alkoxylation product of a monol represented by the formula: R—OH, where R is described above. As set forth above, R is typically a linear hydrocarbon group. Specific examples of suitable monols include, but are not limited to, methanol, ethanol, propanol, butanol, pentanol, hexanol, heptanol, octanol, and combinations thereof.

The resulting polyether monol is represented by the formula:

H(AO)_{X}OR

where A, x, and R are defined above.

The aromatic isocyanate component is represented by the following general formula:

Y(NCO)_{Z}

where Y is the aromatic core as described above and “Z1”, “Z2”, “Z3”, and “Z4” are defined above and represent the number of isocyanate groups present in the aromatic isocyanate component. Suitable isocyanates for purposes of the present invention include, but are not limited to, diphenylmethane diisocyanates (MDIs), polymeric diphenylmethane diisocyanates (PMDIs), toluene diisocyanates (TDIs), and combinations thereof. Polymeric diphenylmethane diisocyanates are also referred to in the art as polymethylene polyphenylene polyisocyanates. Typically, the aromatic isocyanate component is MDI, TDI, or a combination thereof.

The adduct is typically prepared by reacting the aromatic isocyanate component and the polyether monol in the absence of the polar liquid component, especially when the polar liquid component is water, due to the potential reactivity of the aromatic isocyanate component with the polar liquid component. After preparation of the adduct, the adduct may be combined with the polar liquid component, along with other optional components as described in further detail below, to form the solution. It is to be appreciated that, under some circumstances, it may be possible to prepare the adduct in the presence of the polar liquid component.

It is to be appreciated that the actual amount of the adduct present in the solution is subject to application considerations, with the employed concentration depending upon the degree of retention of the polar liquid component desired, the type of substrate to which the solution is applied, and the presence of additional components in the solution (as described in further detail below), among other considerations. However, to achieve practically useful retention of the polar liquid component, the adduct is present in the solution in an amount of at least 1%, alternatively present in the solution in an amount of at least 2%, alternatively present in the solution in an amount of at least 5%, by weight based upon the total weight of the solution. While the maximum amount of the adduct in the solution is not particularly limited, it is preferred that the solution be in liquid or gel form at ambient temperature of 25° C. to enable spraying of the solution. More specifically, the solution is typically in a flowable form and has a sufficiently low viscosity to enable pumping and spraying through conventional devices as described in further detail below. To these ends, the adduct is typically present in the solution in an amount of from 1 to 90% by weight, alternatively from 5 to 50% by weight, alternatively from 5 to 10% by weight, based on the total weight of the solution.

In addition to the polar liquid component and the adduct, the solution may comprise additional components such as one or more types of polymer precursors, botanical treatment components (distinct from the polar liquid component referred to above), fillers and other inert additives, surfactants, catalysts, and combinations thereof. For example, in one embodiment, a stoichiometric excess of the polyether monol (beyond the stoichiometric equivalent necessary to consume the isocyanate functionality of the aromatic isocyanate component for purposes of forming the adduct) may be combined with the aromatic isocyanate component during production of the adduct, and the excess polyether monol remaining after production of the adduct may still be present with the adduct when the adduct and polar liquid component are combined. Stated differently, the solution may comprise the adduct and polyether monol in addition to the polar liquid component. It may be desirable to employ the excess polyether monol to consume isocyanate so that it does not form urea, allophanate, or biuret, particularly when water is added at the end of the process. However, it is to be appreciated that excess polyether monol is not required to be present in the solution in accordance with the instant invention.

When present, the polyether monol is typically present in an amount of less than or equal to 10% by weight, alternatively from 5 to 10% by weight, based upon the total weight of the combined adduct and polyether monol. In one embodiment, the solution is substantially free of polymer precursors (such as the polyether monol), in which case no component of the solution can be further polymerized as any part of a downstream reaction. Even if polymer precursors are present in the solution, the solution is substantially free from components containing free isocyanate functionality in view of the fact that free isocyanate functionality is reactive with water, and further reaction of components in the solution (after formation of the adduct) is undesirable.

As set forth above, the solution may further comprise the botanical treatment component and may be any component that is useful for treatment of plants or fungus. To the extent that any of the polar liquid compounds included in the solution can be characterized as beneficial for treatment of botanical articles, such compounds are included in the group of botanical treatment components referred to herein. The botanical treatment component may be included in the solution for the benefits imparted to the substrate to which the solution is applied and typically performs no functional purpose in the solution in terms of retention of the polar liquid component. The botanical treatment component, when present, is typically present in an amount that is within customary treatment ranges for the specific botanical treatment component.

Examples of suitable botanical treatment components include, but are not limited to, herbicides, pesticides, fungicides, and fertilizers. The terminology “pesticide,” as used herein, is well known in the art and is described at least by the Environmental Protection Agency (EPA), in the Federal Insecticide, Fungicide, and Rodenticide Act (FIFRA), in the Insecticides and Environmental Pesticide Control Subchapter (7 U.S.C. §136(u)), in the Code of Federal Regulations (CFR) relating to the “Protection of Environment,” and in the Regulations of the EPA in 40 CFR §152.3. A pesticide is typically recognized in the art as a substance that is used for preventing, destroying, repelling, regulating, and/or mitigating any pest. A pest is an organism that is deleterious to man or the environment but does not include any internal parasite of living man or other living animal or any fungus, bacterium, virus, or other microorganism on or in living man or other living animals. Said differently, the terminology “pest” does not typically include any organism that infects or sickens humans or animals. In addition, the terminology “pesticide,” as used herein, does not typically include any human or animal drugs or pharmaceuticals, any article that is a “new animal drug” as defined in the art, any liquid sterilant applied to a device used in the human body, and/or any products intended for use against fungi, bacteria, viruses, or other microorganisms in or on living man or living animal. Moreover, the pesticide referred to herein does not typically include drugs or pharmaceuticals used to control diseases of humans or animals (such as livestock and pets).

The solution may also include additional chemical compounds that are not botanical treatment components. Examples of such additional components include, but are not limited to, activators, anti-feedants, anti-fouling agents, attractant agents, chemosterilants, disinfectant agents, fumigant agents, pheromones, repellent agents, defoliants, desiccants, insect growth regulators, plant growth regulators, synergists, adjuvants, and combinations thereof.

While it is to be appreciated that the solution may contain additional components as set forth above, the solution typically contains less than or equal to 5% by weight, based upon the total weight of the solution, of urethane-containing compounds other than the adduct. The presence of other urethane-containing compounds may interfere with the performance of the adduct in terms of retaining the polar liquid component, and may further affect physical properties of the solution such as miscibility of the components in the solution. Typically, the solution is substantially free of urethane-containing compounds other than the adduct.

In one embodiment, the solution consists essentially of the polar liquid component, the adduct that is different from the polar liquid component, optionally, the botanical treatment component and, optionally, the urethane-containing compound other than the adduct present in an amount of less than or equal to 5% by weight based upon the total weight of the solution. In this embodiment, the solution is free from any other polymers or any other chemical compounds that materially affect the basic and novel characteristics of the solution. More specifically, in this embodiment, the solution is free from additional components that would affect properties of the solution relative to retention of the polar liquid component (which, for purposes of the instant application, is deemed to be the basic and novel feature of the solution). In this regard, the solution is typically free from urethane-containing compounds other than the adduct. Also in this regard, the solution is typically free from emulsifiers, tackifing resins, dispersants, thickeners, plasticizers, pigments, and compounds that emit visible light on exposure to UV light.

The solution is typically pourable at room temperature. However, it is to be appreciated that the solution may be non-pourable at room temperature and pourable at an elevated temperature, such at a temperature of at least 80° C. In one embodiment, the solution has a viscosity of less than or equal to 20,000 Cps at room temperature. It is to be appreciated that the solution having the maximum viscosity as set forth above is capable of spray application. Lesser viscosities are possible and may be preferred based upon particular application equipment to be used.

A substrate may be treated with the solution described herein in accordance with various embodiments of the instant invention for purposes of delivering the polar liquid component to the substrate. To these ends, the solution may be applied to various types of substrates for diverse purposes. For example, in one embodiment, the solution may be applied to substrates for purposes including, but not limited to, dust abatement, hydration, and inhibition of solidification of liquid and/or semi-solid compositions (e.g., through extended hydration). Substrates that may benefit from the dust abatement and hydration features of the solution include substrates selected from the group of, but not limit to, soil, gravel, stone, slag, sand, and combinations thereof. Substrates that may benefit from inhibition of solidification include powder compositions such as cement. In this embodiment, the solution is mixed with the powder composition. In another embodiment, the substrate is further defined as a botanical article, such as grass, crops, or seeds, and the solution may be applied to the botanical article not only for hydration purposes, but also for purposes of delivering the botanical treatment agents as described above. In all embodiments, the substrate may be undisturbed immediately prior to application of the solution onto the substrate. More specifically, the substrate may be disposed on the ground or in a found state (e.g., a gravel road) immediately prior to application of the solution, as distinct from substrates that may be involved in manufacturing processes for purposes of making products.

In an alternative embodiment, the adduct may be provided in the form of a solid wax at room temperature and may be mixed with other components, as set forth above, but in the absence of the polar liquid component such that the resulting mixture is in solid (i.e., non-pourable) form at room temperature. The solid adduct or mixture including the adduct may be melted to coat the substrate (such as when the substrate is a botanical article such as seeds), followed by cooling to form a solid-coated substrate. Alternatively still, the solid adduct or mixture including the adduct can be crumbled and combined with other solid materials to form a granulated mixture. For example, the solid adduct or mixture including the adduct could be crumbled and mixed with soil or a seed-containing mixture to form the granulated mixture including the solid adduct.

The following examples are intended to illustrate the invention and are not to be viewed as limiting to the invention.

### EXAMPLES

Various samples of an adduct to be included in a solution in accordance with the instant invention may be prepared as described as follows. A polyether monol is provided that comprises the etherification product of a monol. An aromatic isocyanate component and the polyether monol are reacted at a stoichiometric equivalent or less of reactive isocyanate groups in the aromatic isocyanate component to free hydroxyl groups and water in the polyether monol to produce the adduct. If the adduct begins to solidify during the reaction of the aromatic isocyanate component and the polyether monol, additional polyether monol or water may be added to maintain fluidity. The following Table I illustrates specific reactants and amounts thereof that may be employed to prepare the adducts, with all amounts represented in percent by weight based upon the total weight of all components present during reaction.

TABLE I

| | Ad- | Ad- | Ad- | Ad- | Ad- | Ad- | |
|---|---|---|---|---|---|---|---|
| | duct | duct | duct | duct | duct | duct | Adduct |
| Component | 1 | 2 | 3 | 4 | 5 | 6 | 7 |
| Isocyanate A | 14.8 | — | — | 19.1 | — | — | — |
| Isocyanate B | — | 21.1 | — | — | 26.8 | 10 | 3.91 |
| Isocyanate C | — | — | 36.8 | — | — | — | — |
| Polyether Monol C | — | — | — | — | — | 90 | 96.09 |
| Polyether Monol A | 85.2 | 78.9 | 63.2 | — | — | — | — |
| Polyether Monol B | — | — | — | 80.5 | 73.0 | — | — |
| Catalyst A | — | — | — | ~0.4 | ~0.2 | — | — |
| Total | 100.0 | 100.0 | 100.0 | 100.0 | 100.0 | 100.0 | 100.0 |

Isocyanate A is a toluene diisocyanate commercially available from BASF Corporation of Florham Park, N.J.

Isocyanate B is a polymeric diphenylmethane diisocyanate having a nominal functionality of about 2.7 and about 31.5% by weight of isocyanato groups, commercially available from BASF Corporation.

Isocyanate C is a diphenylmethane diisocyanate having a nominal functionality of about 2.0 and about 33.6% by weight of isocyanato groups, commercially available from BASF Corporation.

Polyether Monol A is the reaction product of methanol and ethylene oxide and has a number average molecular weight of about 500 g/mol, commercially available from BASF Corporation.

Polyether Monol B is the reaction product of methanol and ethylene oxide and has a number average molecular weight of about 350 g/mol, commercially available from BASF Corporation.

Polyether Monol C is a reaction product of methanol and ethylene oxide with a number average molecular weight of approximately 3000 g/mol.

Catalyst is DABCO® 33-LV catalyst commercially available from Air Products and Chemicals, Inc. of Allentown, Pa.

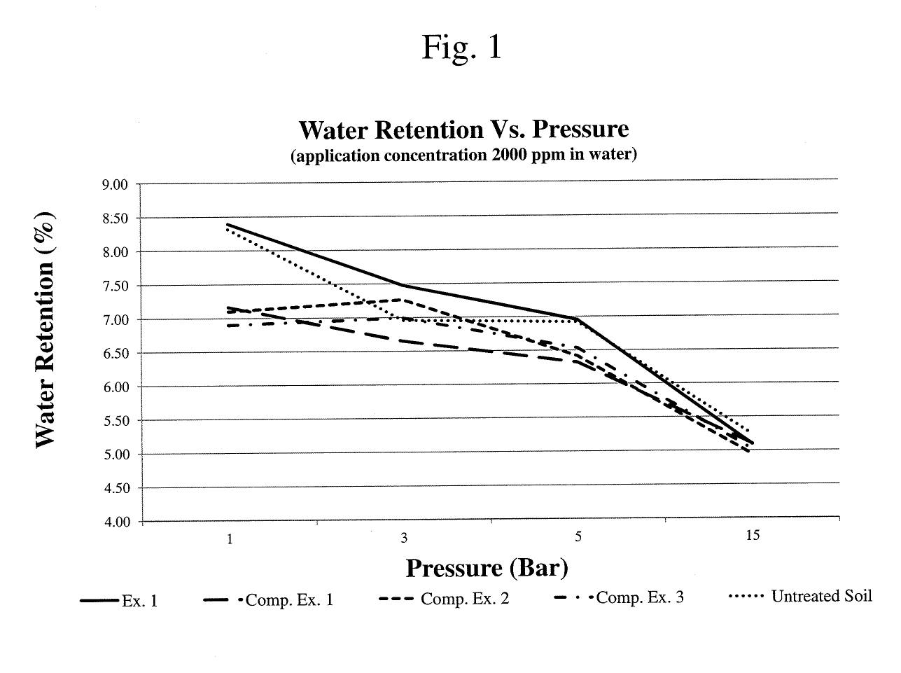

Adduct 7 is formed as set forth in Table 1 above and, in turn, used to form Examples 1-3, which are tested to determine their impact on water retention in soil. More specifically, Adduct 7 is mixed with water to form solutions comprising 2000, 5000, and 8000 ppm of Adduct 7—Examples 1, 2, and 3, respectively. Once Examples 1-3 are formed, 1 gram of each Example is added to 350 grams of soil to yield soils samples which include 5.71, 14.29, and 22.86 ppm of Adduct 7, respectively. The soil samples are then analyzed for water retention at various pressures, which represent various climate conditions (as is discussed in detail further below). The results of the water retention testing is set fort in Tables 2-4 below and represented graphically in FIGS. 1-3.

The soil samples are deposited into and leveled across the top of retaining rings which are 1 centimeter high by 5.5 centimeters in diameter. The ceramic plate has pores of a specific size, which allow water to migrate to and from the soil samples. There are different ceramic plates, having different pore sizes, which allow for experiments based on the surface tension of the liquid medium. Each ceramic plate is approximately 10.25 inches in diameter and sealed one side by a thin butyl diaphragm. An internal screen keeps the diaphragm from contacting the ceramic plate and provides a passage for flow of water. An outlet stem running through the ceramic plate connects this passageway to the outflow tube assembly.

Once the soil samples are deposited into the retaining rings, the ceramic plate having the retaining rings thereon is immersed in de-ionized water to a level which allows water to infiltrate the rings from below and saturate the soil samples. After the soil samples are saturated with water, excess water is carefully removed from the surface of the ceramic plate and the ceramic plate is placed into a SoilMoisture 1500F1 extractor, which is essentially a pressure chamber. The SoilMoisture 1500F1 extractor is manufactured by SoilMoisture Equipment Corp of Santa Barbara, Calif. The extractor is large enough to allow four ceramic plates having multiple retaining rings filled with soil samples thereon to be stacked on top of one another. When the extractor is closed and pressurized with nitrogen, the water is removed from the ceramic plates with small diameter outflow tubes, described above. Said differently, the small diameter outflow tubes provide for the outflow of water from the chamber. Water is trapped in the pores of the ceramic plates as well as the soil samples due to the surface tension of the water. Water migrates from the soil samples through the pores in the ceramic plates until equilibrium is established. The smaller the pore size, the greater the pressure that can be used to extract water from the soil samples. Greater pressures simulate more arid conditions where water is less available to plants. Four different ceramic plates (having different pore sizes) are used to test the impact of Examples 1, 2, and 3 on the water retention of the soil samples—1 Bar, 3 Bar, 5 Bar, and 15 Bar. The samples are left in the extractor until equilibrium is reached.

To measure water retention, each soil sample is removed from the ceramic plate and weighed on a scale in an aluminum weighing pan to determine a wet weight (W_{w}). Each sample, still in the aluminum weighing pan, is heated in an oven at 105° C. for 16 hours to remove all water and weighed to determine a dry weight (W_{d}). The moisture content is then determined with the following equation: ((W_{w}—W_{d})/W_{d})×100. Water retention values for soil treated with Examples 1, 2, and 3, untreated soil, and soil treated with various Comparative Examples are determined and set forth in Tables 2, 3, and 4 below.

TABLE 2

| | | Water | Water | Water | Water |
|---|---|---|---|---|---|
| | | Retention | Retention | Retention | Retention |
| Sample ID | | @ 1 bar | @ 3 bar | @ 5 bar | @ 15 bar |
| Example 1 | 1 | 8.38 | 7.17 | 6.73 | 5.08 |
| | 2 | 8.04 | 7.66 | 6.82 | 5.04 |
| | 3 | 8.62 | 7.30 | 7.04 | 5.05 |
| | 4 | 8.53 | 7.78 | 7.22 | 5.19 |
| | Avg. | 8.39 | 7.48 | 6.95 | 5.09 |
| Comparative | 1 | 7.14 | 6.45 | 6.29 | 5.06 |
| Example 1 | 2 | 7.23 | 6.74 | 6.36 | 5.10 |
| | 3 | 7.13 | 6.71 | 6.36 | 5.14 |
| | 4 | 7.14 | 6.70 | 6.27 | 5.09 |
| | Avg. | 7.16 | 6.65 | 6.32 | 5.10 |
| Comparative | 1 | 7.12 | 7.23 | 6.37 | 5.10 |
| Example 2 | 2 | 7.21 | 7.24 | 6.36 | 5.02 |
| | 3 | 7.04 | 7.44 | 6.43 | 4.76 |
| | 4 | 7.01 | 7.13 | 6.49 | 4.88 |
| | Avg. | 7.10 | 7.26 | 6.41 | 4.94 |
| Comparative | 1 | 6.91 | 7.14 | 6.58 | 4.86 |
| Example 3 | 2 | 6.88 | 6.84 | 6.52 | 5.01 |
| | 3 | 6.97 | 6.75 | 6.51 | 5.01 |
| | 4 | 6.83 | 7.24 | 6.52 | 5.18 |
| | Avg. | 6.90 | 6.99 | 6.53 | 5.02 |
| Untreated Soil | 1 | 8.51 | 6.86 | 6.81 | 5.27 |
| | 2 | 8.34 | 6.90 | 6.90 | 5.25 |
| | 3 | 8.23 | 6.92 | 7.00 | 5.24 |
| | 4 | 8.53 | 6.98 | 6.97 | 5.27 |
| | 5 | 8.29 | 6.89 | 6.96 | 5.22 |
| | 6 | 8.14 | 6.97 | 6.99 | 5.19 |
| | 7 | 7.95 | 6.99 | 6.88 | 5.25 |
| | 8 | 8.18 | 7.12 | 6.98 | 5.18 |
| | 9 | 8.34 | 6.97 | 6.85 | 5.15 |
| | 10 | 8.99 | 6.91 | 6.90 | 5.25 |
| | 11 | 8.32 | 6.98 | 6.87 | 5.33 |
| | 12 | 7.96 | 7.00 | 6.94 | 5.27 |
| | Avg. | 8.32 | 6.96 | 6.92 | 5.24 |

Example 1 is a 2000 ppm solution of Adduct 7 in water.

Comparative Example 1 is a 2000 ppm solution of LESCO® EcoSential Moisture Manager in water. LESCO® EcoSential Moisture Manager is commercially available from John Deere Landscapes of Alpharetta, Ga.

Comparative Example 2 is a 2000 ppm solution of REVOLUTION® in water. REVOLUTION® 50 is commercially available from Aquatrols® of Paulsboro, N.J.

Comparative Example 3 is a 2000 ppm solution of RESERVOIR® 50 in water. RESERVOIR® 50 is commercially available from Helena Chemical Company of Collierville, Tenn.

Untreated Soil is from BASF AG Research Farm, Field 3A, Dinuba, Calif.

The impact of Example 1 and Comparative Examples 1-3 on the water retention of soil at various pressures is set forth in Table 2 and FIG. 1. Notably, Example 1 and Comparative Examples 1-3 are employed at the same concentration, i.e., 1 gram of a 2000 ppm solution of each Example/Comparative Example in water is applied to 350 grams of soil. Referring now to Table 2 and FIG. 1, Example 1 yields greater water retention at low pressures than Comparative Examples 1-3 as well as untreated soil. Further, Example 1 retains less water at high pressures than Comparative Examples 1-3, which indicates that Example 1 facilitates the release of water from the soil (and to the surrounding vegetation) should environmental conditions become more arid.

TABLE 3

| | | Water | Water | Water | Water |
|---|---|---|---|---|---|
| | | Retention | Retention | Retention | Retention |
| Sample ID | | @ 1 bar | @ 3 bar | @ 5 bar | @ 15 bar |
| Example 2 | 1 | 10.45 | 7.28 | 7.11 | 4.74 |
| | 2 | 9.27 | 7.36 | 7.16 | 5.23 |
| | 3 | 10.57 | 7.28 | 6.67 | 4.92 |
| | 4 | 9.19 | 7.33 | 6.97 | 4.99 |
| | Avg. | 9.87 | 7.31 | 6.98 | 4.97 |
| Comparative | 1 | 6.96 | 6.26 | 6.30 | 5.15 |
| Example 4 | 2 | 6.95 | 6.53 | 6.19 | 5.08 |
| | 3 | 6.98 | 6.47 | 6.26 | 5.06 |
| | 4 | 7.05 | 6.57 | 6.20 | 5.12 |
| | Avg. | 6.99 | 6.46 | 6.24 | 5.10 |
| Comparative | 1 | 6.99 | 7.17 | 6.38 | 4.65 |
| Example 5 | 2 | 6.81 | 7.26 | 6.38 | 4.84 |
| | 3 | 6.83 | 7.39 | 6.32 | 4.98 |
| | 4 | 6.82 | 7.23 | 6.58 | 5.71 |
| | Avg. | 6.86 | 7.26 | 6.42 | 5.05 |
| Comparative | 1 | 6.88 | 6.91 | 6.71 | 5.43 |
| Example 6 | 2 | 6.88 | 7.15 | 6.74 | 5.63 |
| | 3 | 6.79 | 7.39 | 6.78 | 5.31 |
| | 4 | 6.82 | 7.34 | 6.64 | 5.35 |
| | Avg. | 6.84 | 7.20 | 6.72 | 5.43 |
| Untreated Soil | 1 | 8.34 | 6.90 | 6.90 | 5.25 |
| | 2 | 8.23 | 6.92 | 7.00 | 5.24 |
| | 3 | 8.53 | 6.98 | 6.97 | 5.27 |
| | 4 | 8.29 | 6.89 | 6.96 | 5.22 |
| | 5 | 8.14 | 6.97 | 6.99 | 5.19 |
| | 6 | 7.95 | 6.99 | 6.88 | 5.25 |
| | 7 | 8.18 | 7.12 | 6.98 | 5.18 |
| | 8 | 8.34 | 6.97 | 6.85 | 5.15 |
| | 9 | 8.99 | 6.91 | 6.90 | 5.25 |
| | 10 | 8.32 | 6.98 | 6.87 | 5.33 |
| | 11 | 8.51 | 6.86 | 6.81 | 5.27 |
| | 12 | 7.96 | 7.00 | 6.94 | 5.27 |
| | Avg. | 8.32 | 6.96 | 6.92 | 5.24 |

Example 2 is a 5000 ppm solution of Adduct 7 in water.

Comparative Example 4 is a 5000 ppm solution of LESCO® EcoSential Moisture Manager in water. LESCO® EcoSential Moisture Manager is commercially available from John Deere Landscapes of Alpharetta, Ga.

Comparative Example 5 is a 5000 ppm solution of REVOLUTION® in water. REVOLUTION® is commercially available from Aquatrols® of Paulsboro, N.J.

Comparative Example 6 is a 5000 ppm solution of REVOLUTION® in water. REVOLUTION® is commercially available from Helena Chemical Company of Collierville, Tenn.

Untreated Soil is from BASF AG Research Farm, Field 3A, Dinuba, Calif.

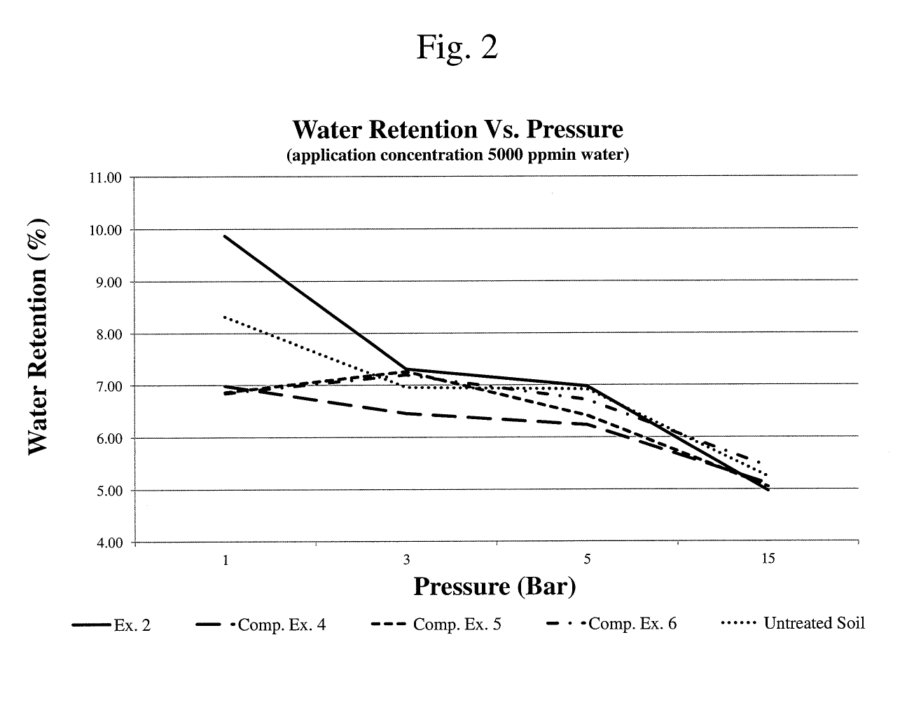

The impact of Example 2 and Comparative Examples 4-6 on the water retention of soil at various pressures is set forth in Table 3 and FIG. 2. Notably, Example 2 and Comparative Examples 4-6 are employed at the same concentration, i.e., 1 gram of a 5000 ppm solution of each Example/Comparative Example in water is applied to 350 grams of soil. Referring now to Table 3 and FIG. 2, Example 2 yields greater water retention at low pressures than Comparative Examples 4-6 as well as untreated soil. Further, Example 2 retains less water at high pressures than Comparative Examples 4-6, which indicates that Example 2 facilitates the release of water from the soil (and to the surrounding vegetation) should environmental conditions become more arid.

TABLE 4

| | | Water | Water | Water | Water |
|---|---|---|---|---|---|
| | | Retention | Retention | Retention | Retention |
| Sample ID | | @ 1 bar | @ 3 bar | @ 5 bar | @ 15 bar |
| Example 3 | 1 | 8.49 | 7.26 | 6.77 | 4.53 |
| | 2 | 8.39 | 7.23 | 6.87 | 4.69 |
| | 3 | 9.05 | 7.27 | 6.89 | 4.68 |
| | 4 | 9.80 | 7.26 | 6.91 | 4.64 |
| | Avg. | 8.93 | 7.26 | 6.86 | 4.64 |
| Comparative | 1 | 7.03 | 6.50 | 6.32 | 5.16 |
| Example 7 | 2 | 6.95 | 6.42 | 6.33 | 5.07 |
| | 3 | 6.85 | 6.57 | 6.27 | 5.10 |
| | 4 | 7.15 | 6.43 | 6.13 | 5.18 |
| | Avg. | 7.00 | 6.48 | 6.26 | 5.13 |
| Comparative | 1 | 6.75 | 7.14 | 6.46 | 4.90 |
| Example 8 | 2 | 6.78 | 7.39 | 6.51 | 4.94 |
| | 3 | 6.88 | 7.22 | 6.47 | 5.11 |
| | 4 | 6.76 | 6.99 | 6.39 | 5.01 |
| | Avg. | 6.79 | 7.19 | 6.46 | 4.99 |
| Comparative | 1 | 6.79 | 7.22 | 6.65 | 6.61 |
| Example 9 | 2 | 6.79 | 7.65 | 6.61 | 5.25 |
| | 3 | 6.68 | 7.65 | 6.68 | 5.33 |
| | 4 | 6.89 | 7.41 | 6.67 | 5.24 |
| | Avg. | 6.79 | 7.48 | 6.65 | 5.61 |
| Untreated Soil | 1 | 8.34 | 6.90 | 6.90 | 5.25 |
| | 2 | 8.23 | 6.92 | 7.00 | 5.24 |
| | 3 | 8.53 | 6.98 | 6.97 | 5.27 |
| | 4 | 8.29 | 6.89 | 6.96 | 5.22 |
| | 5 | 8.14 | 6.97 | 6.99 | 5.19 |
| | 6 | 7.95 | 6.99 | 6.88 | 5.25 |
| | 7 | 8.18 | 7.12 | 6.98 | 5.18 |
| | 8 | 8.34 | 6.97 | 6.85 | 5.15 |
| | 9 | 8.99 | 6.91 | 6.90 | 5.25 |
| | 10 | 8.32 | 6.98 | 6.87 | 5.33 |
| | 11 | 8.51 | 6.86 | 6.81 | 5.27 |
| | 12 | 7.96 | 7.00 | 6.94 | 5.27 |
| | Avg. | 8.32 | 6.96 | 6.92 | 5.24 |

Example 3 is an 8000 ppm solution of Adduct 7 in water.

Comparative Example 7 is an 8000 ppm solution of LESCO® EcoSential Moisture Manager in water. LESCO® EcoSential Moisture Manager is commercially available from John Deere Landscapes of Alpharetta, Ga.

Comparative Example 8 is an 8000 ppm solution of REVOLUTION® in water. REVOLUTION® is commercially available from Aquatrols® of Paulsboro, N.J.

Comparative Example 9 is an 8000 ppm solution of RESERVOIR® 50 in water. RESERVOIR® 50 is commercially available from Helena Chemical Company of Collierville, Tenn.

Untreated Soil is from BASF AG Research Farm, Field 3A, Dinuba, Calif.

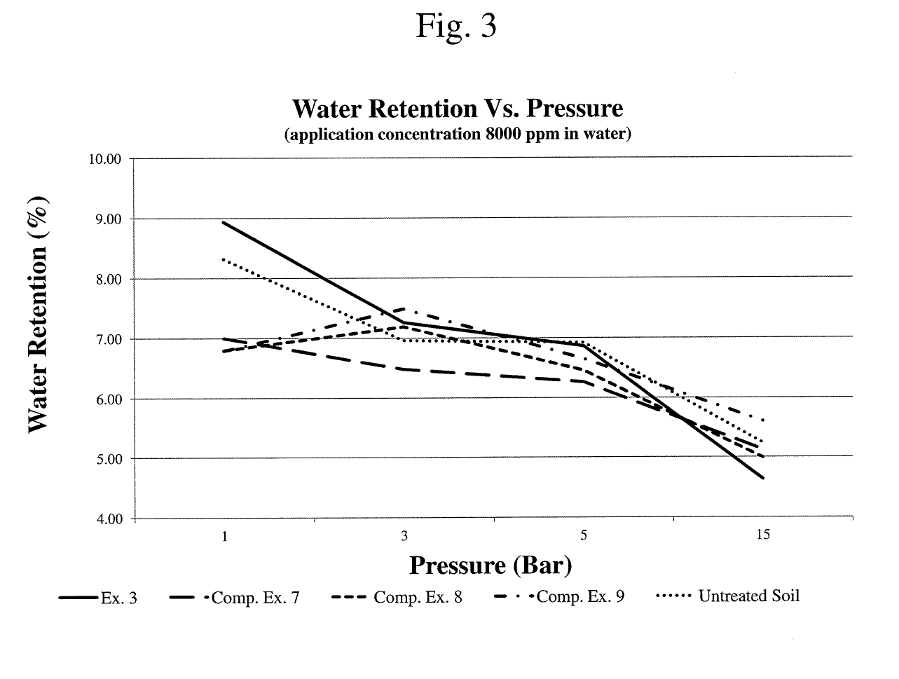

The impact of Example 3 and Comparative Examples 7-9 on the water retention of soil at various pressures is set forth in Table 4 and FIG. 3. Notably, Example 3 and Comparative Examples 7-9 are employed at the same concentration, i.e., 1 gram of an 8000 ppm solution of each Example/Comparative Example in water is applied to 350 grams of soil. Referring now to Table 4 and FIG. 3, Example 3 yields greater water retention at low pressures than Comparative Examples 7-9 as well as untreated soil. Further, Example 3 retains less water at high pressures than Comparative Examples 7-9, which indicates that Example 3 facilitates the release of water from the soil (and to the surrounding vegetation) should environmental conditions become more arid.

Obviously, many modifications and variations of the present invention are possible in light of the above teachings, and the invention may be practiced otherwise than as specifically described within the scope of the appended claims. It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, it is to be appreciated that different, special, and/or unexpected results may be obtained from each member of the respective Markush group independent from all other Markush members. Each member of a Markush group may be relied upon individually and or in combination and provides adequate support for specific embodiments within the scope of the appended claims.

It is also to be understood that any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

1. A solution comprising:
a polar liquid component;
at least 2% by weight based upon the total weight of said solution of an adduct different from said polar liquid component and comprising at least one of:
(A) NH₂Y(HNCO(AO)_{X}OR)_{Z1};
(B) (RO(AO)_{X}CONH)_{Z2}YHNCONHY(HNCO(AO)_{X}OR)_{Z3}; and
(C) Y(HNCO(AO)_{X}OR)_{Z4}
where
Y is an aromatic core derived from an aromatic isocyanate component;
A is an alkylene group selected from the group of ethylene groups, propylene groups, butylene groups, and combinations thereof;
R is a hydrocarbon group having from 1 to 20 carbon atoms;
X is at least 6;
Z₁ is at least 1;
Z₂ is at least 1;
Z₃ is at least 1;
Z₄ is at least 2; and
wherein said adduct is substantially free of unreacted isocyanate groups.

2. A solution as set forth in claim 1 comprising less than or equal to 5% by weight, based upon the total weight of said solution, of urethane-containing compounds other than said adduct.

3. A solution as set forth in claim 1 wherein said adduct comprises greater than or equal to 20% by weight (A) based on the total weight of said adduct.

4. A solution as set forth in claim 3 wherein (A) has a number average molecular weight of from 1,000 to 5,000 g/mol.

5. A solution as set forth in claim 4 wherein (A) includes ethyleneoxy groups in an amount of from 85 to 99.9% by mole based upon the total number of alkyleneoxy units present in (AO)_{X} of (A).

6. A solution as set forth in claim 1 wherein said adduct comprises greater than or equal to 90% by weight (C) based on the total weight of said adduct.

7. A solution as set forth in claim 6 wherein (C) has a number average molecular weight of from 6,300 to 10,000 g/mol.

8. A solution as set forth in claim 7 wherein (C) includes ethyleneoxy groups in an amount of from 85 to 99.9% by mole based upon the total number of alkyleneoxy units present in (AO)_{X} of (C).

9. A solution as set forth in claim 1 wherein said adduct comprises the reaction product of an aromatic isocyanate component and a polyether monol.

10. A solution as set forth in claim 9 wherein said aromatic isocyanate comprises polymeric diphenylmethane diisocyanate and has an NCO content of about 31.5 weight percent and said polyether monol comprises the reaction product of methanol and ethylene oxide.

11. A solution as set forth in claim 1 substantially free of polymer precursors.

12. A solution as set forth in claim 1 that is pourable at room temperature.

13. A solution as set forth in claim 1 wherein:
said polar liquid component is water;
A is an ethyleneoxy group;
R is a hydrocarbon group having from 1 to 5 carbon atoms;
X is from 10 to 90;
Z₁ is from 1 to 4;
Z₂ is from 1 to 4;
Z₃ is from 1 to 4; and
Z₄ is from 2 to 4.

14. A solution consisting essentially of:
a polar liquid component;
at least 2% by weight based upon the total weight of said solution of an adduct different from said polar liquid component and which comprises at least one of:
(A) NH₂Y(HNCO(AO)_{X}OR)_{Z1};
(B) (RO(AO)_{X} CONH)_{Z2}YHNCONHY(HNCO (AO)_{X}OR)_{Z3}; and
(C) Y(HNCO(AO)_{X}OR)_{Z4}
where
Y is an aromatic core derived from an aromatic isocyanate component;
A is an alkylene group selected from the group of ethylene groups, propylene groups, butylene groups, and combinations thereof;
X is at least 6;
Z₁ is at least 1;
Z₂ is at least 1;
Z₃ is at least 1;
Z₄ is at least 2; and
wherein said adduct is substantially free of unreacted isocyanate groups; and optionally, a botanical treatment component.

15. A method of treating a substrate comprising the steps of:
providing a solution comprising:
a polar liquid component;
at least 2% by weight based upon the total weight of the solution of an adduct different from the polar liquid component and which comprises at least one of:
(A) NH₂Y(HNCO(AO)_{X}OR)_{Z1};
(B) (RO(AO)_{X} CONH)_{Z2}YHNCONHY(HNCO (AO)_{X}OR)_{Z3}; and
(C) Y(HNCO(AO)_{X}OR)_{Z4}
where
Y is an aromatic core derived from an aromatic isocyanate component;
A is an alkylene group selected from the group of ethylene groups, propylene groups, butylene groups, and combinations thereof;
R is a hydrocarbon group having from 1 to 20 carbon atoms;
X is at least 6;
Z₁ is at least 1;
Z₂ is at least 1;
Z₃ is at least 1;
Z₄ is at least 2; and
wherein the adduct is substantially free of unreacted isocyanate groups; and applying the solution onto the substrate.

16. A method as set forth in claim 15 wherein the substrate is selected from the group of soil, gravel, stone, slag, sand, and combinations thereof.

17. A method as set forth in claim 15 wherein the substrate is further defined as a powder composition and wherein the solution is mixed with the powder composition.

18. A method as set forth in claim 17 wherein the powder composition is further defined as cement.

19. A method as set forth in claim 15 wherein the substrate is further defined as a botanical article.

20. A method as set forth in claim 15 wherein the substrate is undisturbed immediately prior to application of the solution onto the substrate.

21. A method as set forth in claim 15 wherein the solution is substantially free of urethane-containing compounds other than the adduct.

22. A method as set forth in claim 15 wherein the solution is substantially free of polymer precursors.

23. A method as set forth in claim 15 wherein the solution further comprises a botanical treatment component.

24. A method as set forth in claim 15 wherein the solution is pourable at room temperature.
